(19) United States
(12) Patent Application Publication
(10) Pub. No.: US 2009/0318599 A1
(43) Pub. Date: Dec. 24, 2009

(54) SEALING COMPOSITION, A METHOD FOR PREPARING A SEALING COMPOSITION AND THE USE OF SUCH A SEALING COMPOSITION

(75) Inventor: Thomas Brokamp, Limburg An Der Lahn (DE)

Correspondence Address: CONNOLLY BOVE LODGE & HUTZ, LLP, P O BOX 2207, WILMINGTON, DE, 19899, US

(73) Assignee: Bona GmbH Deutschland, Limburg An Der Lahn (DE)

(21) Appl. No.: 12/484,566

(22) Filed: Jun. 15, 2009

(30) Foreign Application Priority Data
Jun. 19, 2008 (EP) EP08011137.0

(51) Int. Cl. C08K 5/5415

(52) U.S. Cl. 524/261

(57) ABSTRACT

A sealing composition and method to seal building materials, especially cement-based floors, e.g., concrete, with such sealing composition is disclosed. The sealing composition can be used to seal fresh or wet building materials to reduce diffusion of water vapour through the set (hardened) sealing material. The sealing composition is a mixture based on moisture-curing silane functional polymers and monomers that may include hydrocarbon resins and other ingredients.

### CROSS-REFERENCE TO RELATED APPLICATIONS

This application claims priority under 35 USC §119 from European patent application EP 08011137.0 filed Jun. 19, 2008.

### TECHNICAL FIELD

The present invention relates to a sealing composition, a method for preparing a sealing composition and the use of such a sealing composition.

### BACKGROUND ART

Sealing materials for porous building materials on the basis of low viscous polyurethane (typically based on (p)MDI (-prepolymers)) or epoxy resins are well known; an overview can be found in the international patent application WO 2000/00451 related to a method for sealing porous building materials and building components. Similar materials with higher viscosity, in particular on an epoxy base, are also known to work well and are widely available.

Sealing materials based on dispersions are also in use (e.g. Diofan from SolVin France S.A.), but they are only of limited use in the above specified technical field.

Silane functional polymers and their use in compositions for sealants, adhesives and coatings are also well known and understood. The patent application US 2003/0229192 A1 relates to moisture-curable polyether urethanes with reactive silane groups and their use as sealants, adhesives and coatings.

Some adhesives, which are based on silane functional polymers, are also used as a sealant agent against water vapour.

The use of monomeric silanes as masonry water repellents is well known; e.g., Wacker Silicones, Germany, offers several products under the Silres® trademark.

Porous building materials contain often high amounts of water, especially if they are created on site (e.g., concrete). This water can harm other building materials (second materials) attached to them. A sealant can protect this second material from the water coming out of the first material.

After installation, cement-based sub floors are wet for periods of several weeks to several years, in particular in wet environments. Most sub floors are covered with a flooring material, e.g., a hardwood floor. Many of these floors are moisture-sensitive—they might strongly expand and later shrink due to the exposure to a wet sub floor, leading to a damaged floor.

Further damage might arise because of the formation of mould or a hydrolysis reaction of an intermediate adhesive, used for gluing the floor to the sub floor.

To avoid such problems either the sub floor has to be dry or should be dried—which can require a long drying time—or the sub floor has to be sealed.

All the solutions currently known in order to seal porous building materials against uprising water vapour have disadvantages.

Epoxy based material are two component systems and, therefore, the two components have to be mixed prior to application. Both components are hazardous, and the users have a high risk getting health problems.

Polyurethanes based on diphenylmethane diisocyanate (MDI) prepolymers are normally used as a 1-component material. Due to the water-isocyanate reaction and the following formation of carbon dioxide, these materials have a tendency to “foam up” leading to weak coatings. Also these products are hazardous. Further, the isocyanates released out of not completely hardened polyurethane layers can react with aminosilanes in silane based adhesives, leading to a weak, not hardened intermediate layer between the polyurethane sealer and the adhesive.

Water repellent silanes act as a repellent for liquid water. Because they do not form a “coating”, water vapour can easily pass through.

Dispersion-based products are also in use as water vapour barriers. Their applicability is limited, because only very thin layers can be applied. Thicker, more concentrated layers harden very slowly, as the water has difficulties to evaporate.

The use of a silane based adhesive as a moisture barrier is also not satisfying, as very high amounts of adhesive>2 kg/M² have to be applied, leading to a long curing time and difficulties during laying.

Therefore, the industry still seeks a material or mixture of materials to seal building materials that will avoid at least partly the disadvantages described above.

### SUMMARY OF THE INVENTION

The present invention in a first aspect relates to a method to seal building materials, especially cement based floors, e.g., concrete. Furthermore, the invention relates in a second aspect to a sealing composition that is a mixture based on moisture curing silane functional polymers and monomers, hydrocarbon resins and other ingredients. This mixture can be used to seal fresh or wet building materials as mentioned above. The term “seal” in this context is especially related to a strongly reduced diffusion of water vapour through the set (“hardened”) sealing material.

One sealing composition according to the invention is a mixture based on moisture curing silane functional polymers and monomers, hydrocarbon resins and other ingredients the sealing composition comprising:
a) optional a hydro carbon resin preferably in an amount up to 50 (percent by weight (wt-%))
   wherein this resin having a liquid state at a temperature of 23° C., having a viscosity of 0.1 to 20 Pa·s at a temperature of 23° C. and having an OH-content between 0 to 8 OH-%;
b) an alkyltrimethoxysilane and/or an alkyltriethoxysilane and/or an alkyldimethoxymethylsilane or and/or an alkyldiethoxyethylsilane (these expressions are including the oligomers thereof);
c) an aminosilane preferably in an amount of 0.1 to 5 (percent by weight (wt-%)) (this expression including the respective oligomers);
d) optional silica preferably in an amount of up to 50 (percent by weight (wt-%)) and/or pyrogenic silica preferably in an amount of 0.1 to 30 (percent by weight (wt-%));
e) a silane functional polymer with a molecular weight in the range of 500 to 20000 g/mol;
f) optional a catalyst in an amount of 0 to 2 (percent by weight (wt-%)); and
g) calcium and/or magnesium carbonate preferably in an amount up to 0 to 50 (percent by weight (wt-%))(the materials can be grinded or precipitated).
   The mixture can be applied in an easy way in different defined thicknesses with the different tools available in this technical field.

One method according to the invention is a method for preparing a sealing composition for sealing building materials with the following steps:
a) providing a hydrocarbon resin;
b) adding the components:
   i) an alkyltrimethoxysilane and/or an alkyltriethoxysilane and/or an alkyldimethoxymethylsilane and/or an alkyldiethoxyethylsilane,
   ii) an aminosilane,
   and mixing them under protective gas (argon, nitrogen) together with the hydro carbon resin, for a short time—preferably for about 10 min;
c) then adding:
   iii) a precipitated calcium carbonate,
   iv) silica, and/or pyrogenic silica;
d) mixing under static vacuum to a temperature up to about 50 to 80°C., preferably by heating or agitation;
e) then adding one or more silane functional polymers preferably without fillers, and
   continuing the mixing procedure under vacuum;
f) then adding one or more catalysts;
g) continuing mixing under vacuum for another 1 to 5 minutes; and
h) filling the ready-mixed material in buckets, bags or other containers.
   Increasing the temperature of the mixture to about 50 to 80° C. can be done by heating or by agitation.
   Furthermore parts of the hydrocarbon resin might be added before step e). In that way the mixture up to step c) has a higher viscosity and therefore heating by agitation is then more efficient. The present invention is not limited to the use of specific hydrocarbon resin. In principle, one or more hydrocarbon resins known in the art and used in sealing compositions and the like can be employed for the purpose of this invention.

After a waiting time of 1 day the resulting mixture has a nearly Newton-type viscosity in the range of 1 to 100 Pa·s (23° C.) and self-leveling properties. (In contact with normal air the material takes up water and sets (hardens) in 1 to 24 h.)

It has been measured that the hardened films made from the material as mentioned above have a tensile strength>0.5 MPa and an elongation at break>50%. Test samples have dimensions of 20 mm×110 mm cut from film, initial grip distance of Zwick tensile tester is 60 mm and test speed is 60 mm/min.

Furthermore diffusion measurements of water vapour at a temperature of 23° C. from 98% relative air humidity to 50% relative air humidity lead to results in the range 2 to 15 g/(m²·d). Diffusion measurement is conducted according to German standard DIN EN ISO 7783-2 with an amount of 400-1000 g/m² sealing composition on top of a screed sample (thickness 10 mm) placed on top of a sealed cup filled with water in an environment with 50% relative air humidity. Screed sample is prepared according to K. Glas “Zementgebundene Estriche und Industrieböden”, R. Müller Verlag, Köln 1996, ZE30 Rezeptur mit 0,3-0,8 mm Sand.

The mixture is under current European (EU) law not hazardous.

It is preferred to use the sealing composition as disclosed above for sealing building materials, in particular for sealing of cement-based floors, such as floors constructed of concrete.

Preferably the functional polymer should have a molecular weight in the range of 500 to 20000 g/mol. For such a material, e.g., SPUR+ 1010 LM, SPUR+ 1050 by Momentive Performance Materials, USA, or Desmoseal S XP 2458 by Bayer Material Science, Germany, or Geniosil STP-E10, Wacker Silicones, Germany, can be used. In general functional polymers derived from polyurethanes and/or polyethers are preferably used in the inventive sealing composition.

As the catalyst, different catalysts can be used. In any case the catalyst should have the properties such that it catalyses the hydrolysis and condensation reaction of the given prepolymers. Catalysts which can be used are specified in the document US 2003/0229192 A1, the disclosure of which is incorporated herein by reference. If the prepolymer is based on an alpha-silane (e.g. Geniosil STP-E 10), an aminosilane as catalyst is sufficient.

Adding an antioxidant, e.g., Octadecyl-3-(3,5-di-tert-butyl-4-hydroxyphenyl)proprionate), is useful if the cured materials shall be exposed to high temperatures (>40° C.) or light.

If the cured materials shall be exposed to high temperatures (>40° C.) or light also one or more light/UV stabilizers (e.g., bis(1,2,2,6,6-pentamethyl-4-piperidinyl)sebacate) should be added.

It is further possible to add a calcium carbonate (e.g., Omyacarb 10 BG by Omya AG, Switzerland) or a precipitated calcium carbonate; e.g., Schaefer Precarb 100 by Schaefer Kalk Germany, or Socal 312 or Socal U1S1 by Solvay, Belgium; or other fillers to the formulation as an extender up to about 50 (percent by weight (wt-%)).

A sealing composition can have the alkyltrimethoxysilane and/or the alkyltriethoxysilane and/or the alkyldimethoxymethylsilane and/or the alkyldiethoxyethylsilane in an amount of about 0.1 to 10 percent by weight, and preferably about 1 to 5 (percent by weight (wt-%)).

In the above alkyltriethoxysilanes and/or alkyltrimethoxysilanes and/or alkyldimethoxysilanes and/or alkyldiethoxysilanes, the alkyl-moiety can be straight chain or branched alkyl having preferably 1 to 20 carbon atoms, from which straight chain alkyl is preferred. Such compounds are available, e.g., under the Silquest® trademark (Momentive Performance Materials, Albany, N.Y., USA). Especially preferred are octyltriethoxysilane, propyltrimethoxysilane, methyltriethoxysilane, octyltrimethoxysilane and propyltriethoxysilane.

Aminosilanes which can be employed in the present invention are commercially available, e.g. under the Silquest® trademark. Preferred aminosilanes from the Silquest® product line include gamma-aminopropyltriethoxysilane, gamma-aminopropyltrimethoxysilane, gamma-aminopropyidiethoxy-methyl-silane, gamma-aminopropyl-dimethoxy-methyl-silane, and N-(beta-aminoethyl)-gamma-aminopropyltrimethoxysilane.

If required the aminosilane should be added in an amount of about 1 to 5 (percent by weight (wt-%)).

With regard to the silica and/or pyrogenic silica component of the sealing composition according to the invention pyrogenic silica is especially preferred. Respective types pyrogenic are commercially available for example under the HDK® trademark of Wacker Chemie AG, Burghausen, Germany. In principle, the hydrophilic types of silica and/or pyrogenic silica are preferred for the purpose of this invention. However, the hydrophobic types may be used as well.

The content of the silica and/or pyrogenic silica should be in the range of about 1 to 20 (percent by weight (wt-%)).

Preferably the silane functional polymer is included in an amount of about 10 to 60 (percent by weight (wt-%)).

Depending on the chosen catalyst, it may be added in an amount of about 0.1 to 2 (percent by weight (wt-%)).

The sealing composition preferably is applied onto porous sand/cement based plates, specially also for flooring purposes, in an amount of about 200 to 1500 g/m². This amount per square meter is sufficient in order to give the desired low water vapour permeability.

On site, the user can adjust the properties of the mixture further in the following manners:
a) Decreasing setting time and allowing quick bonding in thick layers. For this purpose, water is added as a second component directly to the mixture. In this way hardening times can—if necessary—be reduced up to 95%. This allows also application with a high thickness, where otherwise set times would be long, due to a very slow absorption of water, which is necessary for the setting reaction.
b) Lowering viscosity and better wet-ability of dusty surfaces. For this purpose, it is preferred to add approximately 10% of weight of a solvent so that the viscosity of the mixture can be on site reduced by adding such a solvent. A suitable solvent is e.g., ethanol or white spirit. At the same time, these solvents can also be used for cleaning, e.g., tools.

By adding an epoxy resin, the set mixture will get an increased strength and toughness, and additionally a further reduction of water vapour permeability is achieved. The epoxy does react with the aminosilane, and is therefore chemically bonded to the polymer network.

If the cured materials shall be exposed to high temperatures (>40° C.) or light, an antioxidant (e.g. octadecyl-3-(3,5-di-tert-buty-4-hydroxyphenyl)proprionate) and/or light/UV stabilizers) is/are added (e.g., bis(1,2,2,6,6-pentamethyl-4-piperidinyl)sebacate).

The original mixture is considered to be not hazardous.

The set film is a water vapour barrier, sufficient to lay on new and wet floors without damaging other flooring material on top. This does include the use of leveling compounds, primers, adhesives and other materials, which might be used to lay the flooring material.

While preferred embodiments of the invention have been described and illustrated here, various changes, substitutions and modifications to the described embodiments will become apparent to those of ordinary skill in the art without thereby departing from the scope and spirit of the invention.

What is claimed is:

1. A sealing composition for building materials such as cement or concrete comprising:
a) one or more components selected from the group consisting of: alkyltrimethoxysilane, alkyltriethoxysilane, alkyldimethoxymethylsilane and alkyldiethoxyethylsilane in an amount of about 1 to 10 percent by weight (wt-%) of the sealing composition;
b) an aminosilane in an amount of about 0.1 to 5 percent by weight (wt-%) of the sealing composition;
c) one or more silane functional polymers with a molecular weight in the range of 500 to 20,000 g/mol; and
d) calcium carbonate or magnesium carbonate or a mixture thereof in an amount up to about 50 percent by weight (wt-%) of the sealing composition.

2. The sealing composition according to claim 1, wherein an alkylsilane is used, and the alkyl is a linear or branched alkyl.

3. The sealing composition according to claim 1, wherein the silane functional polymer(s) are selected from the group consisting of methoxy functionalized polymers and ethoxy functionalized polymers.

4. The sealing composition according to claim 1, wherein the silane functional polymer(s) are added in an amount of 5 to 50 percent by weight (wt-%) of the sealing composition.

5. The sealing composition according to claim 1, further comprising a hydrocarbon resin in an amount up to about 50 percent by weight (wt-%).

6. The sealing composition according to claim 1, further comprising an antioxidant or a light/UV stabilizer.

7. The sealing composition according to claim 1, further comprising silica in an amount of up to 50 percent by weight (wt-%) of the sealing composition.

8. The sealing composition according to claim 1, further comprising pyrogenic silica in an amount of 0.1 to 30 percent by weight (wt-%) of the sealing composition.

9. The sealing composition according to claim 1, further comprising a catalyst in an amount of 0 to 2 percent by weight (wt-%) of the sealing composition.

10. A method for making a sealing composition for sealing building materials such as cement or concrete, comprising:
a) mixing together:
i) one or more silane components selected from the group consisting of: alkyltrimethoxysilane, alkyltriethoxysilane, alkyldimethoxymethylsilane and alkyldiethoxyethylsilane, and
ii) an aminosilane,
under protective gas to form a mixture;
b) then adding to the mixture:
iii) a precipitated calcium carbonate,
iv) silica or pyrogenic silica or a mixture of silica and pyrogenic silica;
c) mixing the mixture of a) and with b) materials under static vacuum until such time as the combined mixture reaches a temperature up to about 50 to 80° C.;
d) then adding one or more silane functional polymers and continuing to mix under vacuum; and
e) then adding one or more catalysts and continuing mixing under vacuum until to form the sealing composition.

11. The method according to claim 10, further comprising, heating or agitating the mixture of a) with b) materials.

12. The method according to claim 10, further comprising applying the sealing composition onto porous sand/cement based plates in an amount of 200 to 1500 g/m².

13. The method according to claim 10, further comprising adding a solvent in an amount of about 10 percent by weight (wt.-%) of the sealing composition.

14. The method according to claim 10, further comprising adding one or more epoxy resins, light/UV stabilizers or antioxidants to the sealing composition.

15. The method according to claim 14, wherein the antioxidant is octadecyl-3-(3,5-di-tert-butyl-4-hydroxyphenyl)proprionate).

16. The method according to claim 14, wherein the light/UV stabilizer is bis(1,2,2,6,6-pentamethyl-4-piperidinyl)sebacate.

17. A method for sealing building materials, such as cement or concrete, comprising:
applying a sealing composition to a surface of a building material in an amount of 200 to 1500 g/m², wherein the sealing composition comprises:
a) one or more components selected from the group consisting of: alkyltrimethoxysilane, alkyltriethoxysilane, alkyldimethoxymethylsilane and alkyldiethoxyethylsilane in an amount of about 1 to 10 percent by weight (wt-%) of the sealing composition;
b) an aminosilane in an amount of about 0.1 to 5 percent by weight (wt-%) of the sealing composition;
c) one or more silane functional polymers with a molecular weight in the range of 500 to 20,000 g/mol; and
d) calcium carbonate or magnesium carbonate or a mixture thereof in an amount up to about 50 percent by weight (wt-%) of the sealing composition.

18. The method of claim 17, wherein the sealing composition further comprises one or more hydrocarbon resins in an amount up to about 50 percent by weight (wt-%).

19. The method of claim 17, wherein the sealing composition further comprises silica or pyrogenic silica.

20. The method of claim 17, further comprising adjusting viscosity of the sealing composition with a solvent prior to applying the sealing composition to the building material surface.
